(19) United States
(12) Patent Application Publication
(10) Pub. No.: US 2005/0179331 A1
(43) Pub. Date: Aug. 18, 2005

(54) Energy conversion apparatus with induction machine and method for operating the same

(76) Inventor: Pietro Maddalena, San Donato Milanese (IT)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/508,729

(22) PCT Filed: Mar. 24, 2003
(86) PCT No.: PCT/IT03/00172

(30) Foreign Application Priority Data
Mar. 28, 2002 (IT) MI2002A000643

(51) Int. Cl. H02K 7/06; H02K 7/10

(52) U.S. Cl. 310/80

(57) ABSTRACT

An apparatus for the conversion of electric energy into mechanic energy and vice versa includes a wound-rotor induction machine provided with a stator (S) and a rotor (R) both connected to a same three-phase line (L) through respective connection lines (CS, CR), a motor (M) connected to the rotor (R) and capable to take it to a speed twice the synchronous speed, as well as a step-down transformer (T) and a switch (P) arranged on the connection lines (CS, CR) in such a way as to allow to perform the parallel connection of the stator (S) or of the rotor (R), As a consequence, the machine generates twice the power available for a given size, and weight of iron and copper, because the rotation speed of the machine is twice the synchronous speed and because has a double connection to the line. Furthermore, in this way the induction machine can operate as generator or as synchronous motor.

The present invention relates to apparatuses for the conversion of electric energy into mechanic energy and vice versa, and in particular to an apparatus including an induction machine and the relevant operating method

It is known that there are induction machines suitable to operate as motor, when the rotor rotation speed is lower than the synchronous speed, and as generator, when the rotor rotation speed is higher than the synchronous speed. In this regard it does not matter whether it is the stator or the rotor which acts as induced, and it is also known that both (stator and rotor) may be connected to an AC network.

The main drawback of asynchronous machines is that they are limited to operate around the synchronous speed.

Therefore the object of the present invention is to provide an apparatus which allows to operate a wound-rotor asynchronous motor at a speed twice the synchronous speed, with a parallel connection of stator and rotor to a three-phase line.

The main advantage of the present apparatus is that the present machine generates a double and even greater amount of power available for a given size, and weight of iron and copper. This is because the rotation speed of the machine is twice the synchronous speed and because the machine has a double connection to the line.

Furthermore, in this way the induction machine can operate as generator or as synchronous motor.

Further advantages and characteristics of the apparatus according to the present invention will be clear to those skilled in the art from the following detailed description of some embodiments thereof, with reference to the annexed drawings wherein:

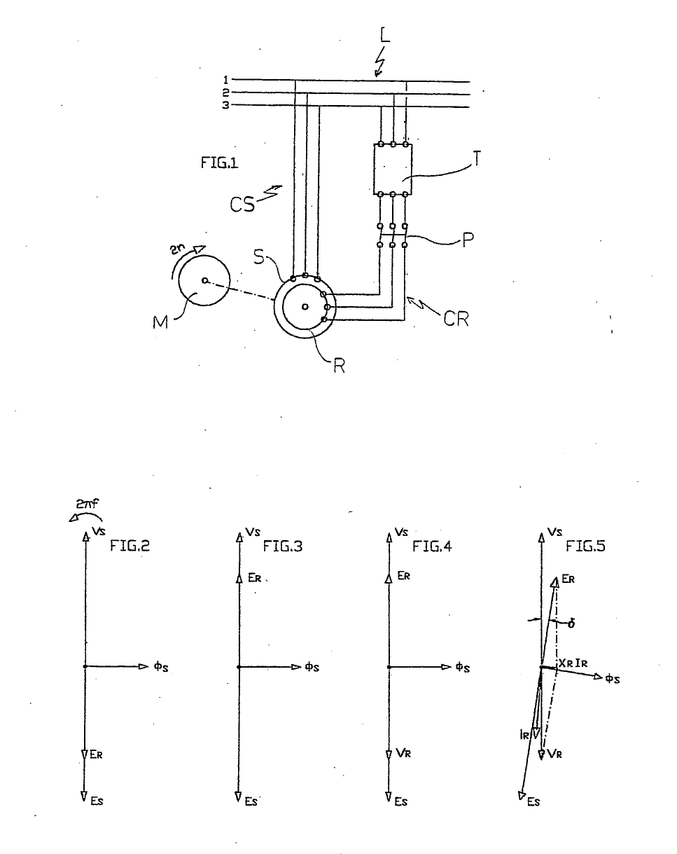

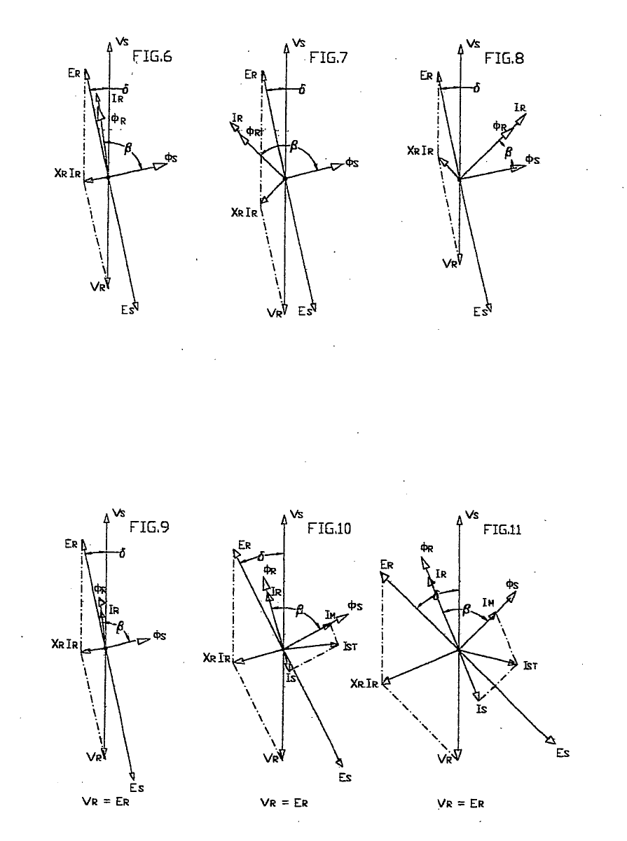

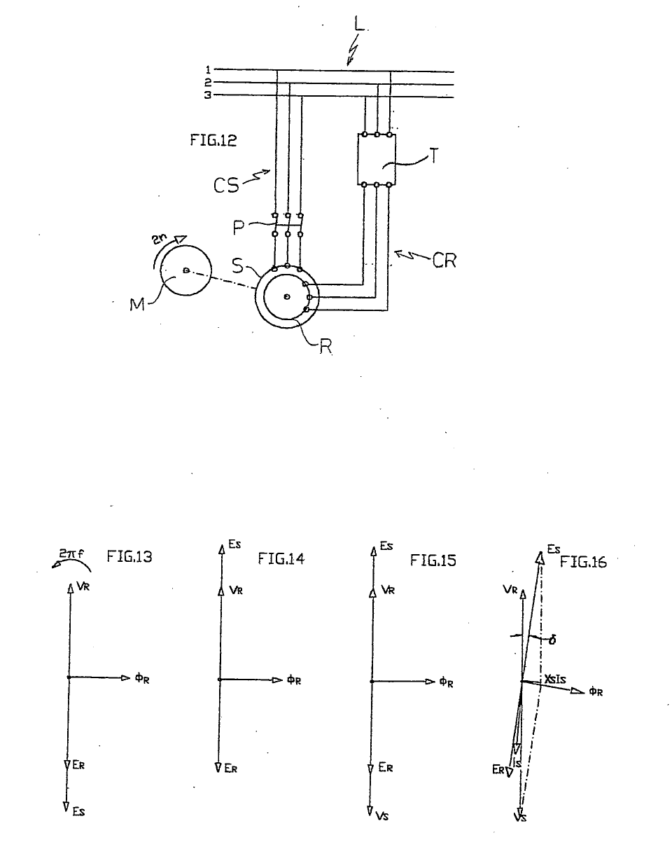

FIG. 1 is a diagrammatic view illustrating a first embodiment of the present apparatus with the parallel connection of the rotor of the induction machine, through a step-down transformer and a switch;

FIGS. 2 to 5 are vector diagrams relating to said machine in the apparatus starting step;

FIGS. 6 to 8 are vector diagrams relating to said machine when operating as generator, with constant ohmic load and variable rotor voltage;

FIGS. 9 to 11 are vector diagrams relating to said machine when operating as generator, with variable ohmic load and constant rotor voltage;

FIG. 12 is a diagrammatic view illustrating a second embodiment of the present apparatus with the parallel connection of the stator of the induction machine, through a switch;

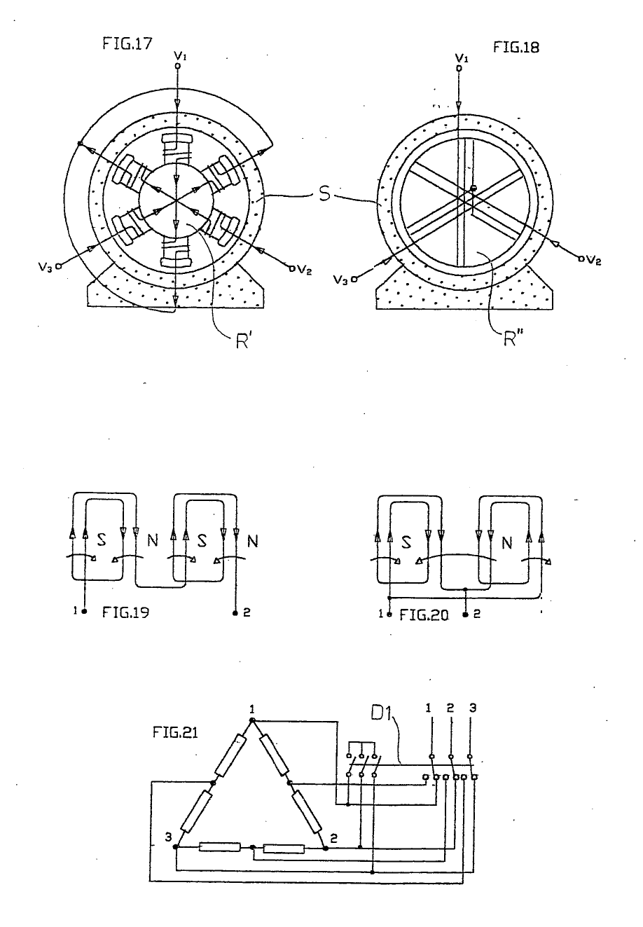

FIGS. 13 to 15 are vector diagrams relating to the above-mentioned second embodiment in the apparatus starting step;

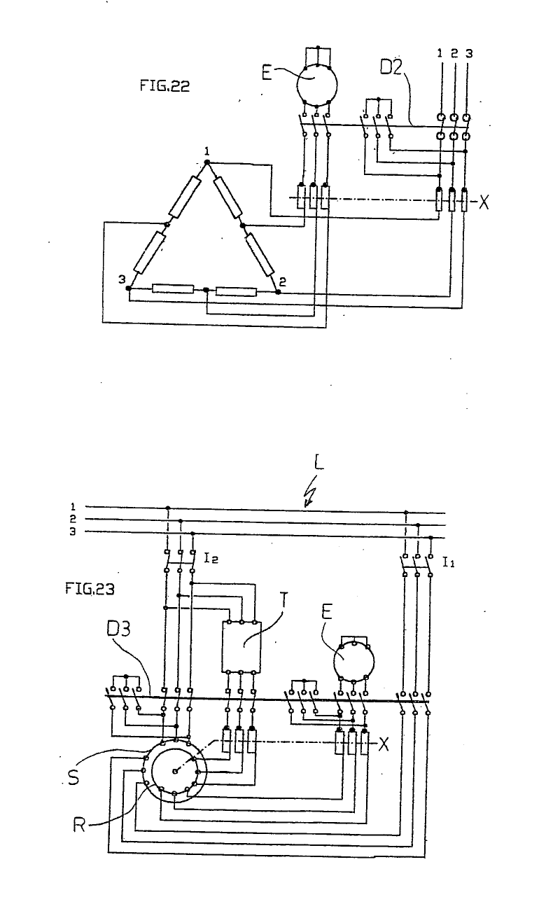

FIGS. 17 and 18 are diagrammatic views of variations of the induction machine with salient poles rotor and smooth poles rotor, respectively;

FIG. 19 shows the connection scheme of two coils connected in series to form 4 poles;

FIG. 20 is a scheme similar to the preceding one of two coils connected in parallel to form 2 poles;

FIG. 21 shows the connection scheme for the switching of the stator from 4 to 2 poles through a double-throw selector;

FIG. 22 is a scheme similar to the preceding one for the switching of the rotor from 4 to 2 poles through a double-throw selector;

FIG. 23 is a diagrammatic view illustrating a third embodiment of the present apparatus with self-starting motor by switching of the currents;

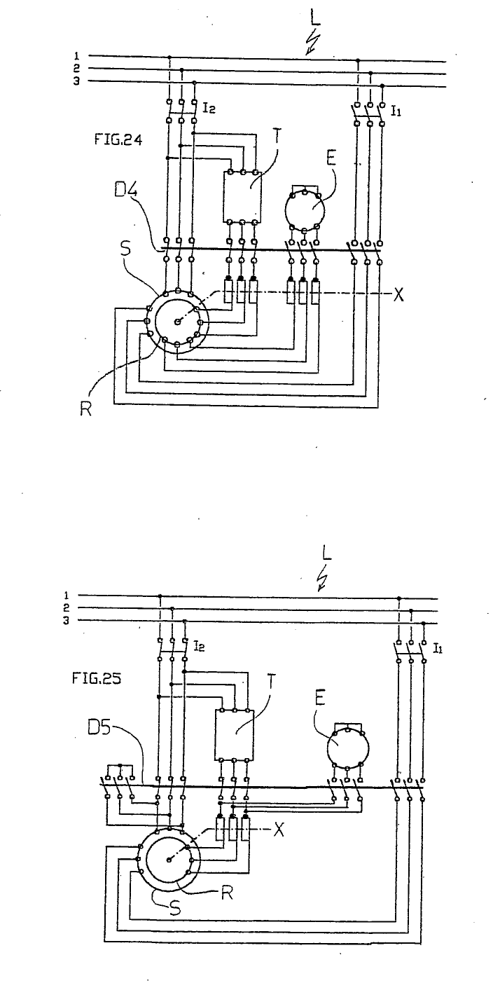

FIG. 24 is a diagrammatic view illustrating a fourth embodiment of the present apparatus with self-starting motor by switching of the windings; and

FIG. 25 is a diagrammatic view illustrating a fifth embodiment of the present apparatus with self-starting, motor by switching of the currents in the stator only.

With reference to FIG. 1, there is seen that a first embodiment of the apparatus according to the present invention includes a wound-rotor induction machine connected to a three-phase line L both at the stator S and at the rotor R, through respective three-phase connection lines CS and CR, and in which on line CR of rotor R there are arranged a step-down transformer T and a switch P, between the machine and transformer T, to perform the parallel connection.

Rotor R is driven by a motor M capable to take it to a speed 2n, where “n” is the synchronous speed in rpm, i.e. n=60*f/p where “f” is the frequency in hertz and “p” the number of pole pairs. The presence of motor M allows to achieve the parallel connection of the rotor according to the operating method described hereunder with reference to the vector diagrams of FIGS. 2-5.

Feeding the stator with voltage V_{S} generates an e.m.f. E_{S} in the stator and an e.m.f. E_{R} in the rotor, both with a 90° delay with respect to the flux Φ_{S}, as indicated in FIG. 2. At the same time, an inductor magnetic field is generated in the stator which rotates clockwise at the synchronous speed n, whereby the inductor field explores the rotor windings with a clockwise cutting speed n.

Causing the rotor to move clockwise reduces the cutting speed until the value becomes equal to zero when the rotor reaches speed n, whereby also the e.m.f. E_{R} decreases until its value becomes equal to zero. However, as soon as the rotor speed exceeds the value n the cutting speed returns, in the anti-clockwise direction, and E_{R} of opposite sign is also generated. Finally, when the rotor reaches the rotation speed 2n the cutting speed reaches the absolute value n and the e.m.f. attains value E_{R} (FIG. 3).

By adjusting the step-down transformer T and the speed of motor M, the e.m.f. values of rotor R are equalized and synchronized with the voltages of the step-down transformer T. Then the parallel connection of rotor R is performed by closing switch P, and in these conditions rotor R neither absorbs nor generates current (FIG. 4).

Finally, motor M is disconnected and the machine continues to rotate driven by its own torque, which is generated because rotor R is subjected to a certain delay (due to the friction) but at the time this delay is generated also the e.m.f E_{R} experiences a phase delay of a certain angle δ with respect to voltage V_{R} (FIG. 5). A current I_{R} therefore flows in rotor R, which current generates an in phase flux Φ_{R} which generates an induced magnetic field, rotating at the same speed and clockwise direction as the inductor magnetic field. The two fields arrange themselves so as to develop a torque capable of compensating the resistant torque.

Therefore the present machine thus connected and operated works in practice as an asynchronous motor but at a synchronous speed, i.e. as if it were a synchronous motor. In fact there are two rotating magnetic fields in which if the two poles lose alignment there is generated an attraction which tends to re-align them.

It should be noted that in the vector diagrams above E_{R} and E_{S} are only the e.m.f induced by the stator flux Φ_{S} in rotor R and stator S respectively, and as such they are always in quadrature with said flux. The corresponding e.m.f. induced by the rotor flux Φ_{R} have not been indicated for the sake of clarity of the diagrams.

With reference to the diagrams of FIGS. 6 to 11, there is now illustrated the operation of the machine as generator, i.e. with motor M which keeps on driving rotor R to convert mechanic energy into electric energy. It is clear that, same as in conventional synchronous machines, there are provided safety systems which stop the operation of the machine if the speed of motor R varies beyond a set threshold.

When operating as a generator, with a purely ohmic load, rotor R generates a current I_{R} in phase with the e.m.f. E_{R}, whereby an induced field is generated which becomes transverse with respect to the inductor. With a purely inductive or capacitive load, rotor R generates a current with a 90° delay or lead phase shift with respect to E_{R}, whereby an induced field is generated which demagnetizes or magnetizes the inductor.

By maintaining the ohmic load constant while changing voltage V_{R}, a change is produced in the angle β between the two fluxes of stator S and rotor R. By setting V_{R}=E_{R}, angle β becomes equal to approximately 90°, and current I_{R} is almost in phase with the e.m.f. E_{R}, whereby the machine generates a real power (FIG. 6).

Setting V_{R}>E_{R} increases β and I_{R} has a lead phase shift with respect to E_{R}, so that in addition to the real power the machine generates a reactive power with capacitive characteristics (FIG. 7). Setting V_{R}<E_{R} decreases β and I_{R} has a delay phase shift with respect to E_{R}, so that in addition to the real power the machine generates a reactive power with inductive characteristics (FIG. 8).

Increasing the ohmic load and maintaining voltage V_{R} constant causes a change from a real power generated by rotor R (FIG. 9 and FIG. 10), to the same power with the addition of another power generated by stator S which is committed to absorbing the magnetizing current I_{M} from the mains supply.

This current I_{M} is combined with current I_{S}, adding up to a total current I_{ST}, which for small values is provided by the mains supply. After exceeding a given load, current I_{ST} reaches such a value and a phase shift as to admit a component in phase with the e.m.f E_{S}, as shown in FIG. 11. In these conditions, stator S supplies a power which combines with the power generated by rotor R.

Similarly, when the machine operates as a motor the result is that rotor R absorbs a current I_{R} which is almost opposite to the current supplied by the machine when operating as a generator. Maintaining the load constant and changing voltage V_{R} causes angle β to change, and by setting V_{R}=E_{R} the value of angle β becomes approximately 90° and there is an induced field transverse with respect to the inductor, i.e. the machine absorbs a real power from the mains supply.

By setting V_{R}>E_{R}, angle β increases and an inductor magnetizing induced field is generated, whereby, in addition to the real power, the absorption of a reactive power with capacitive characteristics occurs. By setting V_{R}<E_{R} angle β decreases and a demagnetizing induced field is generated, whereby, in addition to the real power, the absorption of a reactive power with inductive characteristics occurs.

By increasing the mechanical load and maintaining voltage V_{R} constant, there is a change from a real power absorbed by rotor R to the same power with the addition of a power absorbed by stator S.

FIG. 12 diagrammatically illustrates the second embodiment of the present apparatus which differs from the above-described first embodiment only for the fact that switch P for the parallel connection is arranged on line CS of stator S rather than on line CR of rotor R. Similarly, the vector diagrams of FIGS. 13-16 illustrate the steps of the parallel connection of the stator.

Rotor R, fed by line L through the step-down transformer T, generates the e.m.f. E_{R} and E_{S}, with a 90° delay phase shift with respect to the rotor flux Φ_{R}, as indicated in FIG. 13. At the same time, in rotor R there is generated an inductor magnetic field rotating at the synchronous speed n in the counterclockwise direction.

When rotor R has reached speed 2n, in the clockwise direction, as a consequence of the two rotations, the rotation of the rotor itself and the rotation of the rotating magnetic field, the flux cutting speed is equal to the synchronous speed n, in the clockwise direction, and the e.m.f. E_{S} changes sign (FIG. 14).

By adjusting the step-down transformer T and motor M, the e.m.f. values of stator S are equalized and synchronized with the voltages of line L, and through a synchronization operation the parallel connection of stator S is then performed (FIG. 15) by closing switch P. Finally, motor M is disconnected and the machine continues to rotate driven by its own torque (FIG. 16).

It should be noted that also in this case in the vector diagrams above E_{R} and E_{S} are only the e.m.f induced by the rotor flux Φ_{R} in rotor R and stator S respectively, and as such they are always in quadrature with said flux. The corresponding e.m.f. induced by the rotor flux Φ_{S} have not been indicated for the sake of clarity of the diagrams.

The result in this second embodiment, with the parallel connection of stator S, is therefore that the roles are inverted. Namely, the field of stator S is an induced rotating field and the field of rotor R is an inductor field, but it is possible to find the same relationship between the type of torque applied to the shaft of rotor R and the function of the machine. It should be noted that although the structure of the machine is that of a wound-rotor asynchronous motor, as mentioned above, in the present apparatus it is preferable to increase the number of channels in stator S to a number equal to the number applicable to rotor R, so as to achieve a proportional increase in flux Φ_{S} which results in an overall increase of the efficiency.

Furthermore, the machine may have the rotor with salient poles or smooth poles as diagrammatically illustrated in FIGS. 17-18.

The machine with the salient poles rotor R′ differs from conventional generators in that for each pole pair rotor R′ has one additional pole, and also in that the windings of the poles are fed by a three-phase system, as shown in FIG. 17. A two-pole, or four-pole etc. rotating field is thus generated in rotor R′, depending on the number of salient poles and on how they are connected to each other and to the line. On the contrary, stator S has a structure similar to the structure of the stator of a wound-rotor asynchronous motor.

The machine with smooth rotor R″, for very fast generators, differs from conventional generators in that it has three or six poles, rather than two or four. The windings are housed in deep channels, which are then closed by metal keys. FIG. 18 shows a rotor R″ with three smooth poles which generate a rotating field with a single pole pair. Stator S, also in this case, has a conventional structure.

The machines having these structures can operate as generators or as synchronous motors, as already previously seen.

Other variations of the above-described embodiments are those concerning the possibility of obtaining a self-starting motor by switching of the currents or of the windings.

With reference to FIGS. 19-22 there is seen that when feeding the two ends 1 and 2 of a winding with two coils, four poles are obtained if the latter are connected in series (FIG. 19). On the contrary, if the coils are connected in parallel (FIG. 20) so that the current in one coil is reversed with respect to the direction in the preceding figure, thus performing a switching of the currents, the number of poles is reduced to two.

The whole motor winding includes three identical phases in the stator and an equal number of phases in the rotor. The phases are each formed by the two coils, connected in series or in parallel. The three phases are connected in a delta arrangement if the two coils are connected in series, in a star arrangement if the coils are connected in parallel. Through a double-throw selector D1 or D2, the three phases change the arrangement from delta to star and vice versa, as shown in FIGS. 21 and 22 where E indicates the starting rheostat and X indicates the motor axis. In the rotor it is necessary to position a further three rings to feed the rotor phases when operating as an asynchronous motor, in addition to the three rings for operation as a synchronous motor.

The two-coil winding is the simplest combination, however more complex combinations can be used, with windings where the number of coils is a multiple of two.

In the third embodiment schematized in FIG. 23 there are illustrated the connections and elements required to obtain a self-starting motor by switching of the currents.

In order to perform the parallel connection, stator S and rotor R are switched to the star connection position and the two stator switches I₁ and I₂ are set to the closed position. With the aid of the motor, not shown in the figure and schematized by axis X, rotor R is started so as make it overcome the minimum reluctance position. By progressively excluding the starting rheostat E, there is reached a speed of rotor R which is almost double with respect to the speed of the rotating magnetic field obtained when operating as a synchronous motor.

At this point a comparison is made between the V_{R} of the step-down transformer T and the e.m.f. E_{R} of rotor R. Since the E_{R} value is a fraction of V_{R}, a small transformer is used to obtain a V_{R} which is comparable with E_{R}. When the indicator shows beats of minimum amplitude value, selector D3 is switched to the delta connection position.

This operation performs the parallel connection, shown in FIG. 23, and the motor operates as a synchronous motor. The advice is to set the voltage value V_{R} virtually equal to the voltage value of the rotor e.m.f. E_{R}, which is obtained in the delta connection, before switching to the parallel connection.

In the fourth embodiment schematized in FIG. 24 there are illustrated the connections and elements required to obtain a self-starting motor by switching of the windings.

In this case, the motor has four separate three-phase windings, two of which, one on stator S and the other on rotor R, have half the number of poles and channels per pole with respect to the other two windings. The first two windings are used for the asynchronous operating mode of the motor, the second two windings serve for the synchronous operating mode.

In order to be able to perform the parallel connection, the windings with half the number of poles are connected and then the two stator switches I₁ and I₂ are closed. Then the procedure adopted is the same as described above in the preceding case, up to the moment when it is decided to connect, through selector D4, the windings with twice the number of poles. This operation achieves the parallel connection, as represented in FIG. 24, and the motor operates as a synchronous motor.

Finally, in the fifth embodiment schematized in FIG. 25 there are illustrated the connections and elements required to obtain a self-starting motor by switching of the currents in the stator only. In this way only three rings are required to operate the motor as a synchronous motor.

In fact, in order to be able to perform the parallel connection, only stator S is switched to the star connection position, whereas rotor R remains connected in delta mode. Then the two switches I₁ and I₂ are closed and therefore the operation is the same as above, up to the moment when selector D5 is switched to the delta connection to achieve the parallel connection, represented in FIG. 25, and to operate the motor as a synchronous motor.

It is clear that the above-described and illustrated embodiments of the apparatus according to the invention are just examples susceptible of various modifications. In particular, step-down transformer T can be arranged on the stator line or on the rotor line, according to convenience, and the ratio of the stator voltage to the motor voltage can range from one to ten.

Moreover it is obvious that the number of poles and/or channels and/or windings can be different from the number illustrated in the above-described examples, depending on the manufacturing and operating requirements.

1. Apparatus for the conversion of electric energy into mechanic energy and vice versa, including a wound-rotor induction machine provided with a stator (S) and a rotor (R) both connected to a same three-phase feed line (L) through respective connection lines (CS, CR), and a motor (M) connected to the rotor (R), characterized in that said motor (M) is capable to take the rotor (R) to a speed twice the synchronous speed, and in that it further includes a step-down transformer (T) and at least one switch (P) arranged on said connection lines (CS, CR) in such a way as to allow to perform the parallel connection of the stator (S) or of the rotor (R).

2. Apparatus according to claim 1, characterized in that on the line (CR) of the rotor (R) there are arranged the step-down transformer (T) and a switch (P) located between the induction machine and the step-down transformer (T).

3. Apparatus according to claim 1, characterized in that on the line (CR) of the rotor (R) there is arranged the step-down transformer (T) and on the line (CS) of the stator (S) there is arranged a switch (P).

4. Apparatus according to claim 1, characterized in that the stator (S) and the rotor (R) have the same number of channels.

5. Apparatus according to claim 1, characterized in that the ratio of the stator (S) voltage to the rotor (R) voltage ranges from one to ten.

6. Apparatus according to claim 1, characterized in that the rotor (R) is a salient poles rotor.

7. Apparatus according to claim 1, characterized in that the rotor (R) is a smooth poles rotor.

8. Apparatus according to claim 1, characterized in that it further includes a transformer connected to the step-down transformer (T), a starting rheostat (E), a switch (I₁, I₂) on each of the connection lines (CS, CR) of the stator (S) and of the rotor (R), and a double-throw selector (D1; D2) suitable to change from delta to star and vice versa the connection between the three phases of the stator (S) and of the rotor (R).

9. Apparatus according to claim 8, characterized in that the induction machine operates as a self-starting synchronous motor by switching of the currents in the stator (S) and in the rotor (R), through a relevant double-throw selector (D3).

10. Apparatus according to claim 8, characterized in that the induction machine operates as a self-starting synchronous motor by switching of the windings in the stator (S) and in the rotor (R), through a relevant double-throw selector (D4).

11. Apparatus according to claim 8, characterized in that the induction machine operates as a self-starting synchronous motor by switching of the currents in the stator (S) only, through a relevant double-throw selector (D5).

12. Method for operating an apparatus according to claim 1, characterized in that it includes the following steps:
a) opening the switch (P) arranged on the connection line (CS, CR) which goes to the component of the induction machine, rotor (R) or stator (S), in which the induced magnetic field will be generated;
b) taking the rotor (R), by means of the motor (M), to a speed twice the synchronous speed;
c) acting on the speed of the motor (M) and on the step-down transformer (T) to equalize and synchronize the e.m.f. in the induced element with the voltage in the feed line (L) or in the step-down transformer (T) arranged between the machine and the line (L);
d) closing the switch (P) to perform the parallel connection.
